(19) United States
(12) Patent Application Publication
(10) Pub. No.: US 2018/0370655 A1
(43) Pub. Date: Dec. 27, 2018

(54) SYSTEM FOR TRANSPORTING AND INSTALLING AN INSULATION BLANKET AND ASSOCIATED METHOD

(71) Applicant: Airbus Operations (S.A.S.), Toulouse (FR)

(72) Inventors: Laurent Saint-Marc, Montaigut Sur Save (FR); Bernard Guering, Montrabe (FR)

(21) Appl. No.: 16/014,629

(22) Filed: Jun. 21, 2018

(30) Foreign Application Priority Data
Jun. 23, 2017 (FR) 1755738

(51) Int. Cl. B64F 5/50; B64F 5/10

(52) U.S. Cl. CPC B64F 5/50; B64F 5/10

(57) ABSTRACT

A tool for transporting and installing an insulation blanket in a single piece on a component, for example of an aircraft. The component can have a double-curvature surface like a sealed back which makes the installation difficult given the planar nature of the blanket. The transporting and installing tool operates like an umbrella without fabric at which the ribs are provided with removable attachment devices allowing removable fixing to the insulation blanket. The tool is simple and easy to handle for rapid installation that can be carried out by a single operator.

### CROSS-REFERENCE TO RELATED APPLICATION

This patent application claims priority to French patent application FR 17 55738, filed on Jun. 26, 2017, the entire disclosure of which is incorporated by reference herein.

The disclosure herein relates to the field of tools for transporting and installing insulation blankets particularly for an aircraft component and the transporting and installing method associated with this tool.

### TECHNICAL FIELD

In the aircraft of known types, the system for thermal and sound insulation of a sealed back is made up of several insulation blankets each assembled independently on the sealed back. The result is a long and tedious fitting process due to the number thereof and the varied geometry thereof. Moreover, it is necessary to install the blankets directly on the aircraft which prevents other operations from being carried out in the area in question.

### BACKGROUND

Patent applications FR1663217 and FR1663221 were filed on 22 Dec. 2016 by Airbus Operations SAS disclosing a manner of manufacturing an insulation blanket in a single piece and a method for transporting and fitting it particularly in the cabin, respectively. The disclosure herein takes up the idea of a blanket in a single piece knowing that the latter could be produced according to the manufacturing method explained in the application mentioned below or according to another method. The disclosure herein proposes a tool and a method for transporting and installing an insulation blanket in a single piece for an aircraft component like, for example, a sealed back, with a different configuration to that of the cabin. Indeed, the cabin has a cylindrical geometry, namely with a single curvature. The disclosure herein particularly relates to double-curvature geometry components knowing that it can also apply to single-curvature or even planer components. The design of a tool for a hemispherical-geometry aircraft sealed back is made difficult due to the fact that a hemispherical surface is a non-developable surface: yet the insulation blanket that is to be installed on the sealed back is planar.

The aim of the disclosure herein is to propose a tool for transporting and installing an insulation blanket in a single piece on an aircraft component like the sealed back and an associated method for transporting and installing the blanket.

### SUMMARY

For this purpose, the disclosure herein relates to a system for transporting and installing an insulation blanket in a single piece on a component, wherein it comprises a tool provided with ribs linked in a hinged manner at one of the ends thereof to a shaft, the ribs being radially arranged with respect to the shaft, at least two of them and/or the insulation blanket including at least one removable attachment device allowing the ribs to be removably fixed to the insulation blanket, the blanket being held on the ribs in order to allow it to be transported up to the component on which the blanket is fixed, the ribs being able to move between a so-called open position in which the ribs and the blanket are all located fully in one and the same plane perpendicular to the direction of the shaft and a so-called closed position in which the ribs and the blanket are folded up against the shaft.

The tool has at least one of the following optional features, taken separately or in combination.

The attachment devices on the ribs complement those provided on the blanket.

The insulation blanket and/or the component comprise at least one removable attachment device allowing the blanket to be removably fixed on the component.

The attachment devices on the ribs complement those provided on the blanket.

An actuator can move along the shaft, the actuator bearing spokes via one of the ends thereof, each spoke being coupled to a rib via the other of the ends thereof, the point of connecting the end of the spoke on the rib being located between the two ends of the rib, the spokes driving, when the actuator travels, the ribs between the open position and closed position in which the spokes fold up with the ribs against the shaft, the actuator arriving, at the end of travel, in the open position and in the closed position.

The ribs comprise a point for attaching to a system allowing linking to a cable closed on itself and with a dimension such that it blocks the movement of the attachment points of the ribs when they are spread out before the actuator arrives at the end of travel, the effort of the spoke applied to the rib then bowing it and such that when the actuator arrives at the end of travel in the open position, the ribs have a determined concavity that is identical to that of the component on which the blanket is intended to be fitted.

Several attachment devices are provided per rib.

The attachment devices are of the type having loops or hooks, complementary devices being provided on the insulation blanket intended to be fitted by the tool.

Some ribs have a hinge allowing the rib to pivot around the hinge.

Hinges of the ribs are located on one and the same line.

The point for attaching to the cable is the end of the ribs or, when there is a hinge, at the hinge per se.

The disclosure herein also relates to a method for transporting an insulation blanket in a single piece using the system having the above features, wherein it comprises the following steps:
spreading out the ribs as far as the open position;
placing the ribs on the blanket arranged on a planar surface so as to allow the ribs to be removably fixed on the blanket using the attachment devices;
transporting the insulation blanket using the tool allowing the blanket to be transported up to the component.

The disclosure herein also relates to a method for installing an insulation blanket on a component transported in accordance with the transporting method having the features set out above, and wherein it comprises the following steps:
placing the ribs connected to the insulation blanket against the component;
fixing the blanket on the component.

The installing method comprises the following steps when the component has a double-curvature surface:
closing the tool as far as a position allowing a cable to be linked to each of the ends of the ribs, the cable being closed on itself;
opening the tool until the actuator arrives at the end of travel, the cable allowing the ribs to be bowed so that the blanket has a concavity identical to that of the component.

### BRIEF DESCRIPTION OF THE DRAWINGS

Other aims, advantages and features of the disclosure herein will emerge upon reading the description, which is given by way of nonlimiting example with reference to the appended drawings wherein:

FIG. 1 shows a perspective view of a tool according to the disclosure herein, which tool is ready to be rigidly connected with an insulation blanket resting on a surface S1;

FIG. 2 shows a perspective view of the tool according to FIG. 1 during the step of connecting with the insulation blanket;

FIG. 3 shows a perspective view of the tool according to FIGS. 1 and 2 which is connected to the blanket, in the open position perpendicular to the surface S1;

FIG. 4 shows a perspective view of the tool according to FIGS. 1 through 3, which is connected to the insulation blanket and to which a bowing cable is linked;

FIG. 5 shows a perspective view of the tool according to FIGS. 1 through 4 which is connected to the insulation blanket and to a bowing cable in the open position;

FIG. 6 shows a perspective view of the tool according to FIGS. 1 through 5, in which tool the ribs are hinged and can fold in order to adjust to the geometry of the environment of the sealed back shown in this case by a floor and a frame reinforcement;

FIG. 7 shows a perspective view of the tool according to FIGS. 1 through 6 in the closed position and connected to the insulation blanket and to a bowing cable;

FIG. 8 shows a perspective view of the tool according to FIGS. 1 through 7 in the closed position and connected to the insulation blanket and to a bowing cable carried by an operator up to a sealed back of an aircraft, with only the sealed back of the aircraft being shown;

FIG. 9 shows a perspective view of the tool according to FIGS. 1 through 8 which is connected to the insulation blanket and to a bowing cable, one end of which is linked to the sealed back;

FIG. 10 shows a perspective view of the tool according to FIGS. 1 through 9 which is connected to the insulation blanket and to a bowing cable held in a determined position by a position holding structure;

FIG. 11 shows a perspective view of the tool according to FIGS. 1 through 10 which is connected to the insulation blanket and to a bowing cable as it is being spread out in order to fix the blanket onto the sealed back;

FIG. 12 shows a perspective view of the tool according to FIGS. 1 through 11 which is connected to the insulation blanket and to a bowing cable during the step of fixing the blanket on the sealed back;

FIG. 13 shows a perspective view of the tool according to FIGS. 1 through 12 which is connected to a bowing cable during the step of separating the tool from the blanket;

FIG. 14 shows a spring attachment which can be used to fix the blanket on the sealed back;

FIG. 15 shows a perspective view of the tool according to FIGS. 1 through 14 which is connected to a bowing cable in the closed position, the blanket having been fixed on the sealed back;

FIG. 16 shows a perspective view of an alternative tool to that shown in FIGS. 1 through 15 in the open position for a blanket with a geometry different to that of the blanket of the preceding figures (with the exception of FIG. 14 showing a spring attachment);

FIG. 17 shows a perspective view of a hinge used for the ribs shown in FIG. 6 and allowing them to fold in order to adjust to the geometry of the environment of the sealed back shown in FIG. 6 by a floor and a frame reinforcement;

FIG. 18 shows a simplified perspective exploded view of the hinged rib according to FIG. 6 and of the hinge according to FIG. 17;

FIGS. 19 through 21 show a simplified side view of the hinged rib according to FIG. 18 in three different positions, namely the normal operating position of the rib in FIG. 21 and two retracted positions in FIGS. 19 and 20.

### DETAILED DESCRIPTION

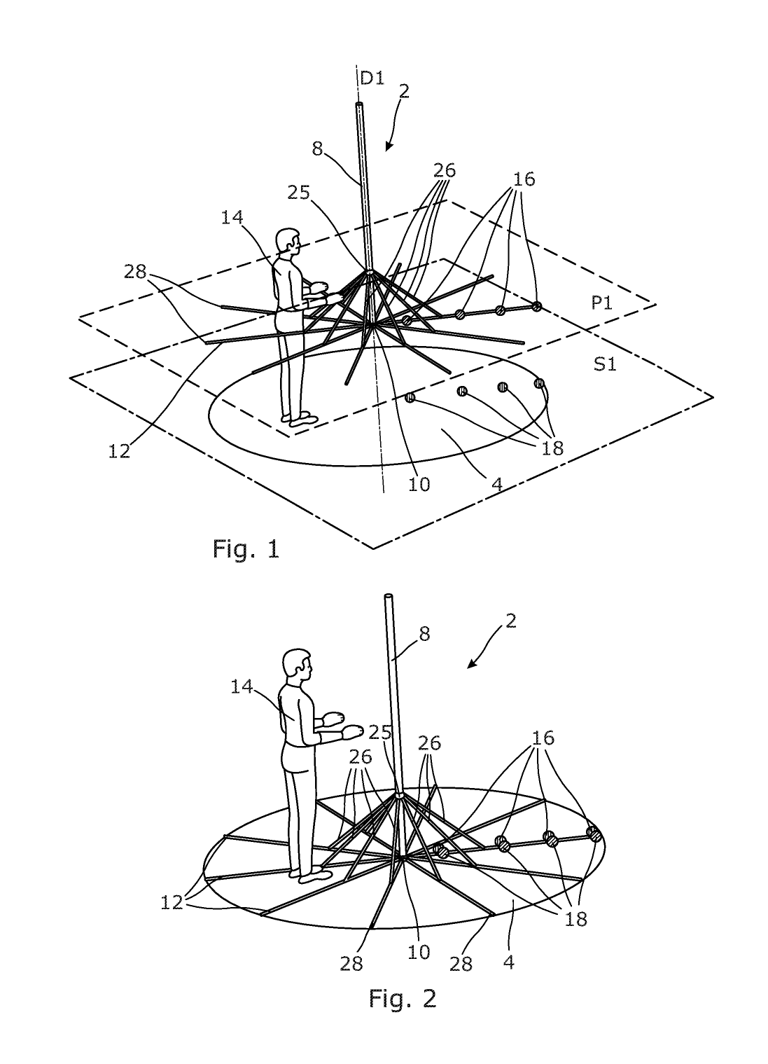

As illustrated in FIGS. 1 through 16, the disclosure herein relates to a tool 2 and to a method for transporting and installing an insulation blanket 4 in a single piece on a component 6 like, for example, that illustrated in the remainder of the description, namely an aircraft sealed back 6 (the sealed back being shown in FIGS. 6, 8 to 13, and 15). As shown, for example, in FIG. 16, the disclosure herein is not limited to the sealed back and could apply to other components of an aircraft or even a transport vehicle, building, etc.

The sealed back of an aircraft can have a planar surface but very often has a double curvature which is the case here. The sealed back has a partially hemispherical shape.

The tool 2 for transporting and fitting the insulation blanket 4 on the sealed back 6 includes a rigid shaft 8 at one of the ends 10 of which ribs 12 are linked in a hinged manner: the term “rib” is used in a similar manner to the operation of umbrellas for which it corresponds to the framework made up of flexible strips over which a fabric is stretched. The end 10 of the shaft will be called the hinged end 10 in the remainder of the description. The ribs are arranged radially with respect to the hinged end 10 of the shaft 8. The hinged end 10 of the shaft 8 offers a rotating hinge point for each of the ribs 12 in a plane comprising the rib 12 in question and the shaft 8. The ribs 12 can move between a so-called open position in which all of the ribs 12 are located entirely in one and the same plane P1 perpendicular to the direction D1 of the shaft 8 and a so-called closed position in which the ribs 12 are folded up against the shaft 8 like a parasol or an umbrella. The mechanism allowing the ribs 12 to rotate about the hinge point between the open and closed positions can be extremely varied as shown, for example, by all of the possible mechanisms for opening/closing a parasol or an umbrella. The remainder of the description will describe a possible mechanism knowing that any other mechanism allowing the described movement of the ribs is suitable.

When the ribs 12 are in the closed position, the tool is portable; a single operator 14 can transport the tool. Moreover, due to having the ribs 12 folded up against the shaft 8, the tool requires little space for the storage thereof.

At least two ribs 12 include removable attachment devices 16 allowing the removable fixing thereof to the insulation blanket 4. The attachment devices 16 can have a form of any type.

According to a specific embodiment, attachment devices are provided on at least two ribs and on the blanket: the attachment devices on the ribs and on the blanket are optionally complementary. According to a possible embodiment as illustrated in the figures, the attachment devices 16 are fixed on the ribs and complementary attachment devices 18 are fixed on the blanket: for example, they can be of the type having loops or hooks.

According to an illustrative embodiment, each rib 12 includes removable attachment devices 16.

As illustrated in FIG. 1 by dots on a single rib, several attachment devices 16 are fixed to the rib 12. They are distributed along the length of the rib in order to ensure better holding of the blanket on the tool. The greater the size of the blanket, the greater the number of attachment devices. According to the illustrated embodiment, complementary attachment devices 18 are provided in a corresponding manner distributed over the blanket 4.

According to an alternative, the removable attachment devices 16 are fixed only on the blanket 4. Fasteners could be provided on the blanket side, which fasten around the ribs on the umbrella side.

The attachment devices 16, 18, irrespective of the embodiment, whether they are complementary or not, can themselves be removable or permanently fixed to the ribs or to the blanket.

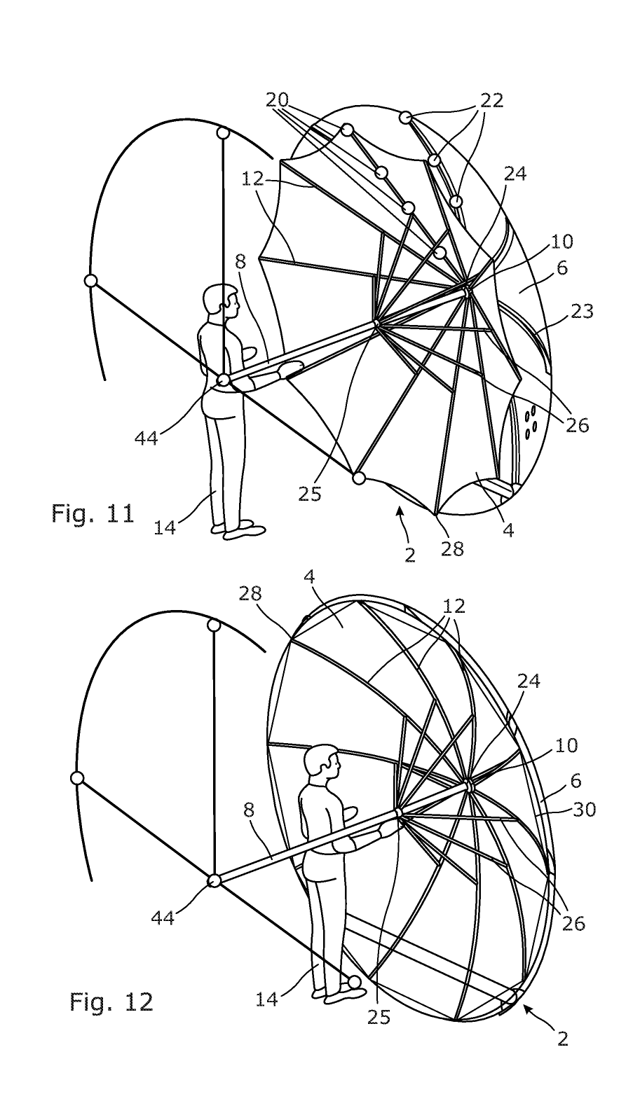

According to an embodiment, the blanket 4 comprises removable attachment devices on the two opposite faces thereof to firstly allow the removable fixing to the tool 2, (which removable attachment devices are designated by the reference 18) and secondly the removable fixing to the component (the sealed back 6 here) (which removable attachment devices are designated by the reference 20 and shown in FIG. 11). Attachment devices 22 (shown in FIG. 11) are provided on the component (the sealed back 6 here) corresponding to the attachment devices 20 provided on the blanket 4. According to an alternative, the attachment devices are not on opposite faces but on one and the same face. The attachment device, whether it is complementary or not, is not necessarily on the face of the blanket facing the rib or the component on which the blanket is to be fixed. The attachment device can be located on the opposite side. Thus, for example, fasteners can be positioned on the opposite face of the blanket to the face facing the component on which the blanket is to be held.

In the same way as for the attachment devices 16, according to an alternative, the removable attachment devices 22 are only on the component. According to an alternative, the attachment devices 22 are located only on the blanket. According to another embodiment, attachment devices are provided on the blanket and on the component: the attachment devices on the blanket and on the component are optionally complementary. In the remainder of the description, attachment devices 20 are provided on the blanket and complementary attachment devices 22 are provided on the component, for example of the type having loops and hooks as for the devices 16 and 18 for attachment of the rib on the blanket.

The attachment devices 20, 22, whether they are complementary or not, can themselves be removable or permanently fixed to the blanket and/or to the component.

According to another embodiment, no removable attachment device is provided on the blanket and/or the component. Permanent attachment devices are used directly.

In the illustrated embodiment (see FIGS. 6, 8 to 13 and 15), the sealed back 6 comprises stiffeners 23 radially arranged around a central point 24. The tool 2 is produced so as to have ribs distributed around the hinged end 10 in the same manner as the stiffeners 23 around the point 24. The attachment devices 22 are linked to the stiffeners of the sealed back and those of the blanket which are provided in order to link thereto in a position corresponding to those of the sealed back on the blanket.

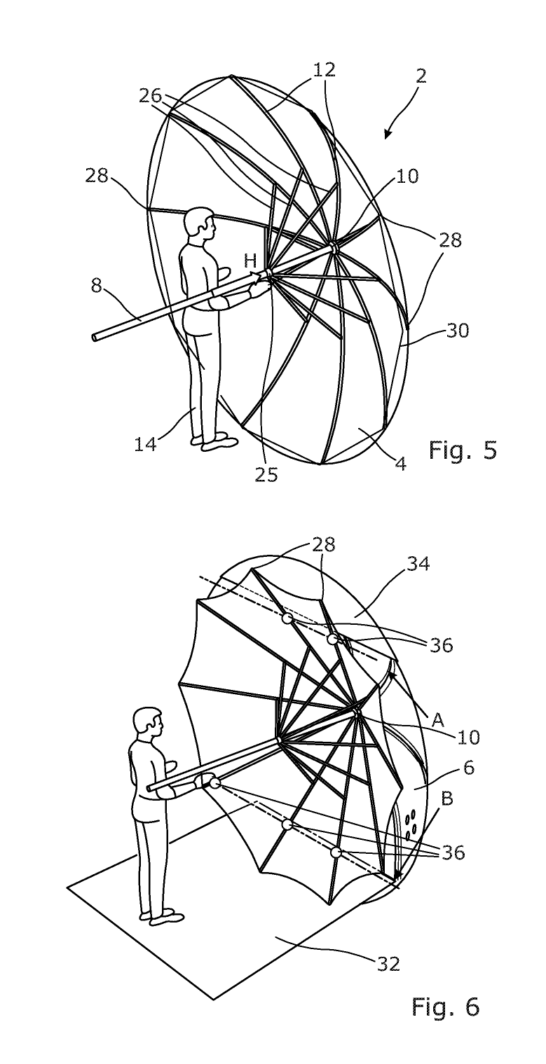

The tool 2 includes an actuator 25 that can move along the shaft 8. The actuator 25 can have a form of any type and, for example, a ring form into which the shaft 8 is introduced and on which the ring 25 slides. Rigid spokes 26 connect the actuator 25 to the ribs 12. One of the ends of the spoke 26 is connected to the actuator 25 and the other end of the spoke is connected to a rib, the point of connecting the end of the spoke 26 to the rib being located between the two ends of the rib. When the actuator 25 slides along the shaft 8 in the direction of the hinged end 10 of the shaft (direction H shown in FIG. 5), it exerts an effort on the spokes 26 which, due to the connection thereof to the ribs, move them away from the shaft 8: the ribs spread out from the retracted closed position thereof along the shaft 8 to the spread-out open position thereof around the hinged end 10 perpendicular to the shaft 8. When the blanket is fixed to the ribs by the attachment devices 16, the ribs move between a so-called open position in which the ribs and the blanket are all located fully in one and the same plane (P1) perpendicular to the direction of the shaft 8 and a so-called closed position in which the ribs and the blanket are folded up against the shaft 8.

The actuator 25 arrives at the end of the translational travel thereof in the open position or in the closed position, respectively. Locking/unlocking structure of any type can be used to block/unblock the actuator 25 in the open position and in the closed position, like a retractable pin, for example: the pin is provided on the shaft 8 inside which it can be retracted. The pin is inserted into a corresponding orifice of the ring 25 and projects outside the ring in order to have access to the pin and allow it to be unlocked.

The end 28 of the ribs 12 comprises a system for retaining a cable 30 closed on itself allowing the ribs to be linked to this cable. The cable 30 can be closed on itself before linking with the ribs 12 or can comprise a closing mechanism allowing it to be closed into a loop again after linking to the ribs. The retaining system can have a form of any type.

According to an embodiment having a cable 30 closed on itself, the ribs 12 are supplied with a tongue that can be folded up on itself in order to form a loop into which the cable 30 is inserted. The tongue comprises structure(s) of any type allowing the tongue to be fixed in a loop in which the cable 30 is held like attachments having hooks and openings, hooks and eyes, buttons, fasteners, etc.

According to an embodiment having an open cable 30 that can be closed on itself, the end of the ribs 12 is pierced: the cable 30 can be inserted into each of the openings made at the end of the ribs 12. The cable 30 is then closed on itself again, each end of the cable 30 being provided with complementary closing structure of suitable type like, for example, a buckle fastener, a satchel clasp, a lobster clasp, etc. The opening of the ribs is produced by a piercing but any other embodiment using an added piece, for example, is possible.

The dimension of the cable 30 is determined so that it blocks the spreading out of the ends 28 of the ribs 12 before the end of the travel of the actuator 25. Although the ends 28 of the ribs 12 are blocked, the actuator 25 can continue the travel thereof due to a certain flexibility of the ribs. The effort of the spoke 26 applied to the rib 12 causes, as a result of the blocking by the cable 30, bowing thereof (see FIG. 5). The dimension of the cable 30 is such that when the actuator 25 arrives at the end of travel in the open position of the tool, the bowed ribs 12 have a determined concavity identical to that of the component on which the blanket 4 is intended to be fitted, namely in this case identical to the concavity of the sealed back 6.

When the operator 14 spreads out the ribs 12, the movement thereof can be hindered or stopped by obstacles in the environment of the component. Thus, for the sealed back 6, a floor 32 on one side and a frame reinforcement 34 on the opposite side to the floor opposes the complete spreading out of the tool (FIG. 6): the end of the ribs 12 is stopped firstly by the floor 32 and secondly by the frame reinforcement 34.

In order to adjust to environments having obstacles to the complete opening of the tool, some ribs 12 have a hinge 36 or a weakened area located on one and the same line; in the illustrated embodiment, the line A represents the line of hinges 36 that are provided to compensate for the presence of the reinforcement 34 and the line B represents that for compensating for the presence of the floor 32. When the end of the ribs 12 is stopped by an obstacle, the ribs 12 can continue the movement thereof by pivoting around the hinge 36 or the weakened area provided on the ribs; the hinge 36 allows the rib to fold up on itself such that the end thereof retracts when faced with the encountered obstacle.

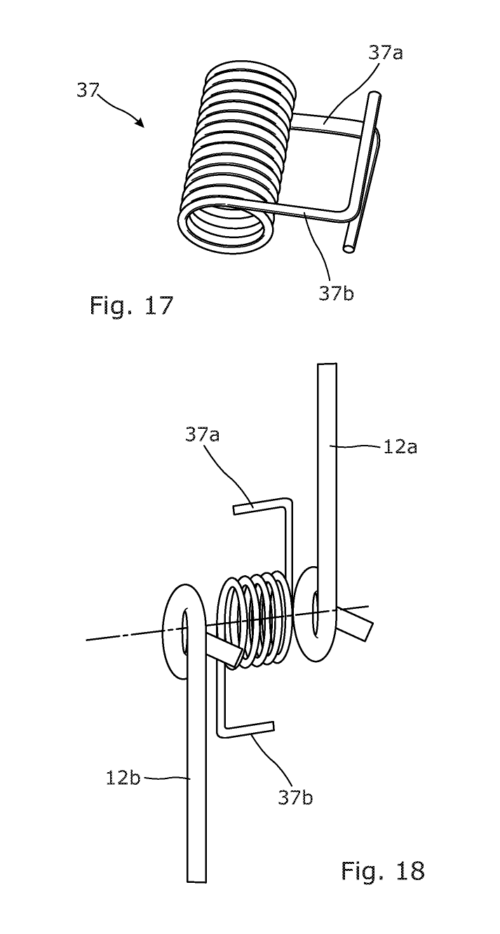

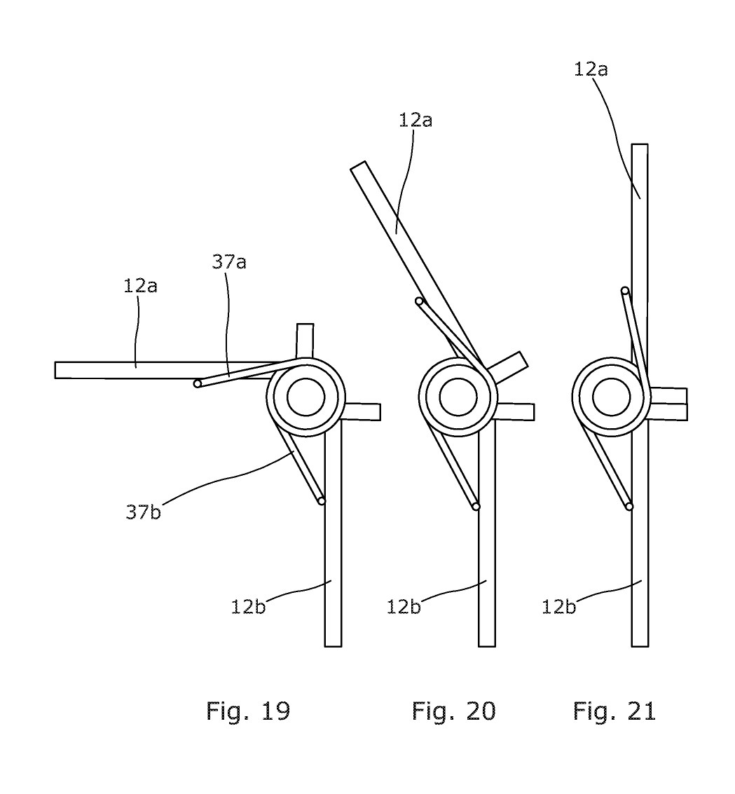

FIGS. 17 through 21 show a possible example of a hinge 36. The hinge is produced using a torsion spring 37. The rib 12 is separated into two independent parts 12a, 12b between which the spring 37 is arranged. In the present case, the rib has a lath form in order to bear on the arms 37a, 37b of the torsion spring. The torsion spring 37 holds the two parts 12a, 12b on one and the same straight line. From a threshold of a determined effort exerted on the end of the rib 12 (namely on the end of a part 12a), knowing that the opposite end of the other part 12b is held by the shaft 8, the part 12a pivots around the hinge 36. When this effort is no longer exerted, the spring again assumes the original position thereof and brings back the part 12a into the continuation of the part 12b.

In the case of a rib 12 lath having a hinge 36, the bowing cable 30 is no longer fitted at the ends of the ribs but at the hinge 36.

FIG. 16 depicts that the tool can be adjusted to the geometry of any component: the ribs 12 do not then all have the same length. In the example of FIG. 16, the component 6 has an oval geometry but it could also have angles and be rectangular, square, etc.

The method for transporting and installing the insulation blanket on a component such as the sealed back 6 comprises the following steps:

In the embodiment illustrated in FIG. 1, the insulation blanket 4 in a single piece rests on a planar surface S1. An operator 14 starts the opening of the tool 2 by sliding the actuator 25 toward the hinged end 10 of the shaft 8 up to the position corresponding to the open position of the tool in which the actuator 25 is blocked using the lock. The ribs 12 are all entirely located on one and the same plane P1. The operator 14 manipulates the tool 2 so as to position the plane P1 of the ribs 12 parallel to the surface S1 and so that the attachment devices 16 of the ribs 12 and the attachment devices 18 of the insulation blanket 4 are located facing one another. The operator then puts the ribs 12 down on the blanket 4.

In the illustrated embodiment, since the attachment devices are systems having loops and hooks, the attachment devices 18 of the blanket 4 catch the attachment devices 16 of the ribs. Four attachment devices are provided on each of the ribs distributed over the length thereof.

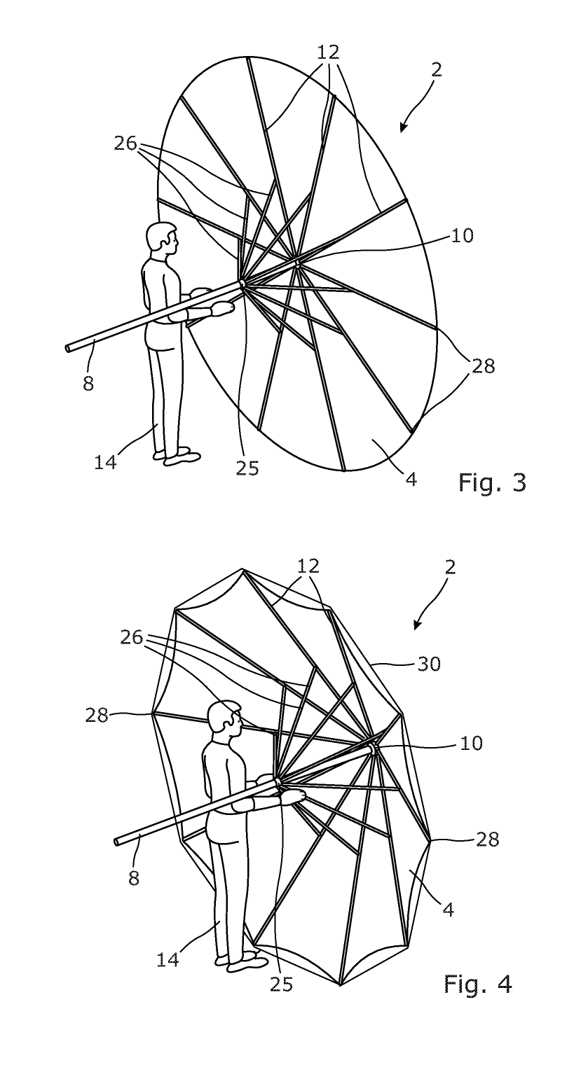

As shown in FIG. 3, the blanket 4 is then fixed over the whole of the surface thereof to the ribs 12. The operator 14 can place the blanket 4 in a position such that the plane P1 of the ribs is perpendicular to the surface S1: the blanket 4 is held in this position by the tool 2. If the operator 14 folds up the tool into the closed position, he or she can then easily transport the insulation blanket 4. The tool makes it possible to transport the blanket 4 easily, for example up to the component 6 on which the blanket 4 is to be fixed. If the component is located in a cluttered environment, it is easier for the operator to install the blanket 4 in an open space, then to transport the tool with the blanket 4 up to the component, and in particular in the present case up to the sealed back 6 located inside an aircraft.

In the case of a sealed back having a planar surface, the tool could be used as is.

In the case of a partially hemispherical sealed back 6 (FIG. 6, 8 through 13, and 15), the operator, as depicted in FIG. 4, fixes a cable 30 to each of the ends 28 of the ribs. The cable 30 has a dimension such that it blocks the ends of the ribs 12 when they move away from the shaft 8 and they arrive at a given distance from the shaft: the cable 30 is then tight. It is therefore necessary for the operator to install the cable 30 on the ribs 12 in a position in which the cable is not tight, namely in a position for the ribs that is between the closed position and the position in which the ribs 12 are blocked by the cable 30.

If the operator uses a cable 30 closed on itself, he or she attaches the cable 30 at each of the ribs 12 by a retention system like the presented retention system having a tongue making it possible to hold the cable inside the loop of the tongue against each of the ribs.

If the operator uses an open cable 30, he or she passes the cable 30 into orifices or the like provided at the end of the ribs 12, then closes the cable on itself again using a closing system provided at each of the ends of the cable 30.

As shown in FIGS. 4 and 5, once the cable 30 is installed, the operator actuates the actuator 25 in order to slide it along the shaft 8 in the direction H; the actuator 25, when travelling, drives the spokes 26. The spokes 26 exert a pushing effort on the ribs 12 which spread out until the cable 30 tightens and stops the movement of the ends of the ribs. With the actuator 25 continuing the travel thereof, the spokes 26 still exert an effort on the ribs 12, the ends of which are blocked, and causes the ribs to bow. When the actuator 25 arrives at the end of travel, the ribs 12 have a concavity equivalent to that of the sealed back 6 as shown in FIG. 5.

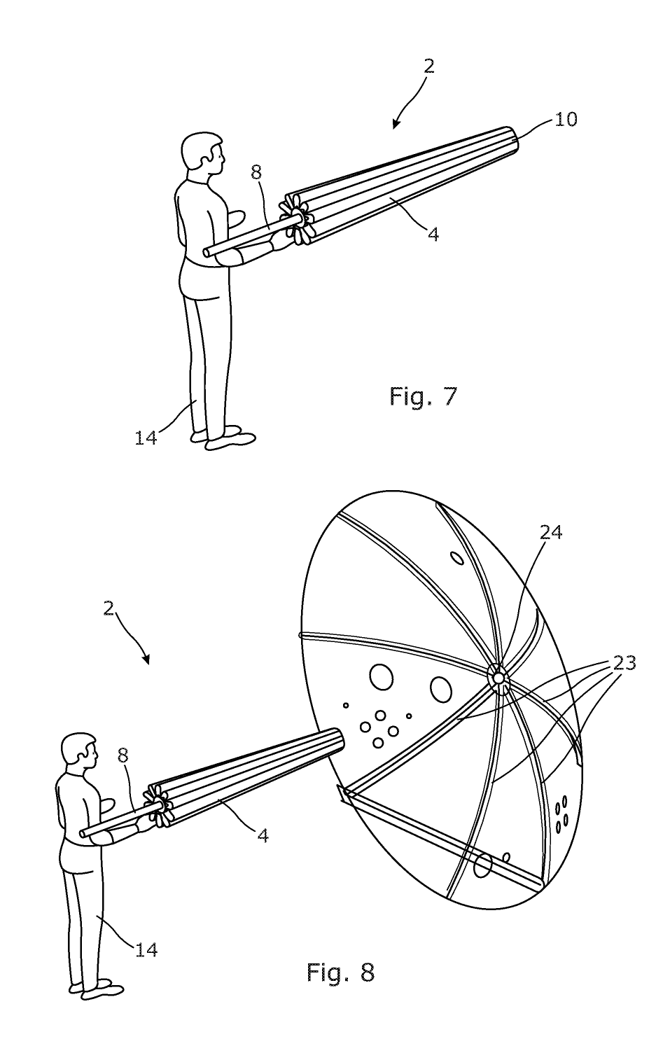

As shown in FIG. 7, the operator 14 closes the tool 2 again into the closed position thereof: the ribs 12 fold up against the shaft 8 and take the blanket with them. Thus, the operator can easily transport the blanket.

As shown in FIG. 8, the operator 14 brings the blanket up to the sealed back 6 inside an aircraft (not shown for the sake of simplification) using the tool.

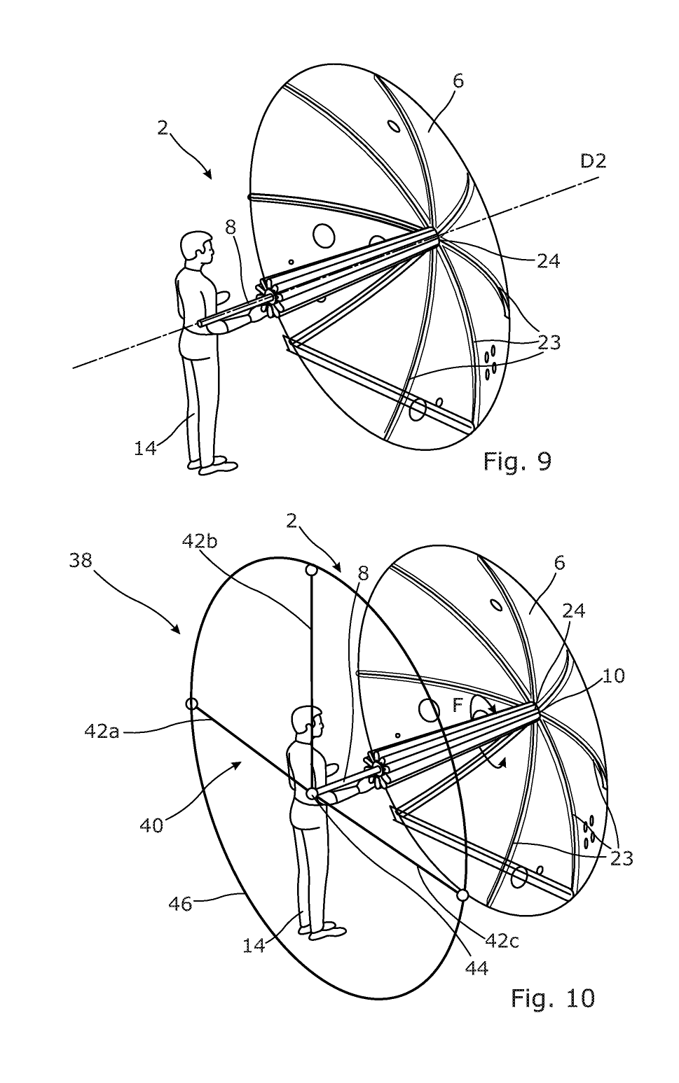

As illustrated in FIG. 9, the operator places the shaft 8 in a direction D2 closest to the position perpendicular with respect to the plane tangent to the partially hemispherical dome formed by the sealed back 6 passing through the central point 24. The operator places the hinged end 10 of the tool on the central point 24 of the sealed back 6.

According to an embodiment, the tool can be handled by a single operator 14. In this case, it is necessary to put in place a complementary position holding structure 38 holding the shaft 8 in the direction D2 such that the operator can have his or her hands free in order to fix the blanket on the sealed back 6.

As shown in FIG. 10, the operator 14 starts by holding the hinged end 10 on the central point 24 of the sealed back using a removable attachment device of any type (see, for example, those stated in the present application) and for example having loops and hooks.

As shown in FIG. 10, the operator 14 then installs a network 40 of holding cables 42 making it possible to hold the other end of the shaft 8 that is opposite the hinged end 10, called the free end 44. Any type of structure 38 can be envisaged as long as it allows holding of the shaft 8 in the direction D2 perpendicular to the plane tangent to the hemispherical dome formed by the sealed back 6 and passing through the central point 24, or in a direction closest thereto. In the illustrated example, the network 40 holds the shaft 8 in suspension with the removable attachment device provided at the central point 24. The operator 14 uses the fuselage of the aircraft, only one frame 46 of which is shown for attaching three cables 42a, 42b, 42c. Using grippers, the operator holds the cables on the frame 46. The cables 42a and 42c are on one and the same straight line as a continuation of one another, cross the fuselage and are located in a direction parallel to the floor 32 (not shown in FIG. 10) on which the operator is located. One of the ends of the cables 42a and 42c is fixed to the frame 46 opposite one another and the other end of the cables 42a and 42c is fixed in a removable manner on the free end 44 of the shaft 8 by any type of known structure or mechanism (for example, hook, loop, etc.). The cable 42b is perpendicular to the cables 42a and 42c. One of the ends thereof is fixed to the frame 46 and the other end is fixed to the free end 44 of the shaft 8 in a removable manner by any type of known structure (for example, hook, loop, etc.). The free end 44 of the shaft 8 is fixed to the point of intersection of the cables 42a, 42b and 42c and to each of them in order to be held so that the shaft 8 is located in the desired direction D2.

As shown by the double arrow F in FIG. 10, the operator, before linking the free end 44 of the shaft 8 to the holding structure 38, can pivot the shaft 8 on itself such that the ribs 12 correspond to the stiffeners 23 of the sealed back 6 if this was not the case.

At this stage, either the operator 14 is alone and the tool is held by the holding structure 38, or several operators carry out the installation of the blanket.

It is considered in the remainder of the description that the operator 14 is alone knowing that the steps are the same in both cases.

The operator 14, in the step displayed in FIG. 12, starts opening the tool. The actuator 25 slides along the shaft 8 in the direction of the hinged end 10 connected to the central point 24 of the sealed back 6 and drives, when travelling, the ribs 12 toward the open position in which the ribs 12 are bowed and with a concavity identical to that of the sealed back 6.

The blanket 4 is superposed on the sealed back 6. The removable devices 20 for attachment provided on the blanket 4 are linked to those 22 provided on the sealed back 6; the loop and hook systems catch one another.

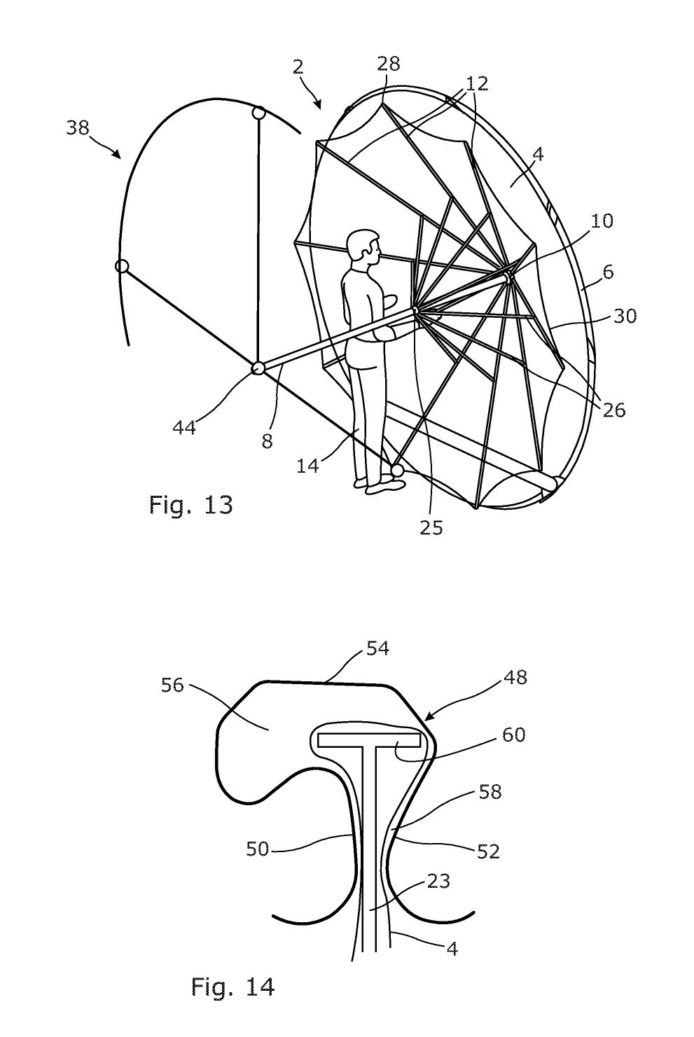

With the blanket 4 being held on the sealed back 6, the operator can detach the tool from the blanket 4 (FIG. 13) and allow more solid fixing to the stiffeners 23 using spring clips 48. In the case where no removable attachment device is provided between the blanket and the sealed back, the operator fits the permanent fixing for example as seen above using clips as he or she detaches the ribs from the blanket.

FIG. 14 illustrates an example of such a spring clip 48 comprising two tabs 50, 52 connected by a head 54 and defining an enlarged space 56 and a narrowing 58. Fitting such a clip consists in or comprises forcing a stiffener 23 of the sealed back 6 to pass through the narrowing 58 taking advantage of the spring nature of the tabs 50, 52, until the projection 60 of the stiffener 23 arrives in the enlarged space 56 and is retained there by the tabs 50, 52. Thus, the spring clips 48 each tightly fit around the blanket 4 and the corresponding stiffener 23.

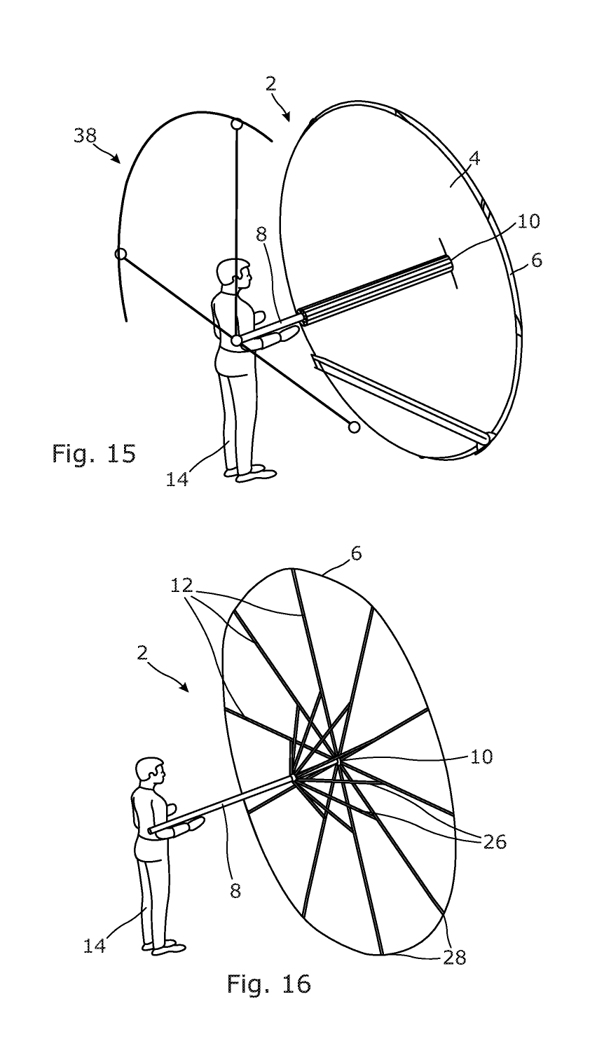

FIG. 15 shows that the blanket 4 has been installed on the sealed back 6. The operator has again closed the tool and uninstalls the holding structure 38.

The installation tool according to the disclosure herein operates like an umbrella without fabric at which the ribs are provided with a removable attachment device allowing fixing to the insulation blanket. The tool is simple and easy to handle for rapid installation without difficulties even if the environment presents obstacles to the use thereof. It is portable. It allows a single operator not only to carry the insulation blanket but also to fit it on double-curvature components like an aircraft sealed back.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for transporting and installing an insulation blanket in a single piece on a component, comprising a tool with ribs linked in a hinged manner at one of an end thereof to a shaft, the ribs being radially arranged with respect to the shaft, at least two of them and/or the insulation blanket including at least one removable attachment device allowing the ribs to be removably fixed to the insulation blanket, the blanket being held on the ribs to allow it to be transported up to the component on which the blanket is fixed, the ribs being movable between an open position in which the ribs and the blanket are all located fully in one and a same plane perpendicular to a direction of the shaft and a closed position in which the ribs and the blanket are folded up against the shaft.

2. The system according to claim 1, wherein attachment devices on the ribs complement attachment devices on the blanket.

3. The system according to claim 2, wherein the insulation blanket and/or the component comprise at least one removable attachment device allowing the blanket to be removably fixed on the component.

4. The system according to claim 3, wherein the attachment devices on the ribs complement the attachment devices on the blanket.

5. The system for transporting and installing an insulation blanket according to claim 1, wherein an actuator is movable along the shaft, the actuator bearing spokes via one of ends thereof, each spoke being coupled to a rib via another of the ends thereof, a point of connecting the end of the spoke on the rib being located between two ends of the rib, the spokes driving, when the actuator travels, the ribs between the open position and closed position in which the spokes fold up with the ribs against the shaft, the actuator arriving, at an end of travel, in the open position and in the closed position.

6. The system for transporting and installing an insulation blanket according to claim 5, wherein the ribs comprise a point for attaching to a system allowing linking to a cable closed on itself and with a dimension such that it blocks the movement of the attachment points of the ribs when they are spread out before the actuator arrives at the end of travel, the effort of the spoke applied to the rib then bowing it and such that when the actuator arrives at the end of travel in the open position, the ribs have a determined concavity that is identical to that of the component on which the blanket is intended to be fitted.

7. The system for transporting and installing an insulation blanket according to claim 1, wherein a plurality of attachment devices are fixed on a rib.

8. The system for transporting and installing an insulation blanket according to claim 1, wherein some ribs have a hinge allowing the rib to pivot around the hinge.

9. The system for transporting and installing an insulation blanket according to claim 8, wherein hinges of the ribs are located on one and the same line.

10. A method for transporting an insulation blanket in a single piece, the method comprising:
providing a system for transporting and installing an insulation blanket in a single piece on a component, comprising a tool with ribs linked in a hinged manner at one of an end thereof to a shaft, the ribs being radially arranged with respect to the shaft, at least two of them and/or the insulation blanket including at least one removable attachment device allowing the ribs to be removably fixed to the insulation blanket, the blanket being held on the ribs to allow it to be transported up to the component on which the blanket is fixed, the ribs being movable between an open position in which the ribs and the blanket are all located fully in one and a same plane perpendicular to a direction of the shaft and a closed position in which the ribs and the blanket are folded up against the shaft,
spreading out the ribs as far as the open position;
placing the ribs on the blanket arranged on a planar surface to allow the ribs to be removably fixed on the blanket using the attachment devices; and
transporting the insulation blanket using the tool allowing the blanket to be transported up to the component.

11. A method for installing an insulation blanket on a component transported in accordance with the transporting method according to claim 10, the method comprising:
placing the ribs connected to the insulation blanket against the component; and
fixing the blanket on the component.

12. The method for installing an insulation blanket according to claim 11,
wherein an actuator is movable along the shaft, the actuator bearing spokes via one of ends thereof, each spoke being coupled to a rib via another of the ends thereof, a point of connecting the end of the spoke on the rib being located between two ends of the rib, the spokes driving, when the actuator travels, the ribs between the open position and closed position in which the spokes fold up with the ribs against the shaft, the actuator arriving, at an end of travel, in the open position and in the closed position, and
wherein the ribs comprise a point for attaching to a system allowing linking to a cable closed on itself and with a dimension such that it blocks the movement of the attachment points of the ribs when they are spread out before the actuator arrives at the end of travel, the effort of the spoke applied to the rib then bowing it and such that when the actuator arrives at the end of travel in the open position, the ribs have a determined concavity that is identical to that of the component on which the blanket is intended to be fitted;
the method comprising steps as follows when the component has a double-curvature surface:
closing the tool as far as a position allowing a cable to be linked to each of the ends of the ribs, the cable being closed on itself; and
opening the tool until the actuator arrives at the end of travel, the cable allowing the ribs to be bowed so that the blanket has a concavity identical to that of the component.
